(19) United States
(12) Patent Application Publication
(10) Pub. No.: US 2004/0216165 A1
(43) Pub. Date: Oct. 28, 2004

(54) Surveillance system and surveillance method with cooperative surveillance terminals

(75) Inventors: Keisuke Inata, Tokyo (JP); Taku Nakamura, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/424,702

(22) Filed: Apr. 25, 2003

(30) Foreign Application Priority Data
Apr. 25, 2003 (JP) 123394

(51) Int. Cl. H04N 7/18

(52) U.S. Cl. 725/105; 348/143

(57) ABSTRACT

The present invention provides a system and method of surveillance to support an early intensive surveillance setup in surrounding areas on the locality of a hazard. A surveillance system of the present invention comprises two or more surveillance terminals and a surveillance center to which the surveillance terminals are connected via a network. Each surveillance terminal comprises a hazard detecting unit, a hazard signal sending unit, and a video data sending unit. The surveillance center comprises a unit for detecting a hazard signal from one or more of the surveillance terminals and a command sending unit for sending a surveillance command to the two or more surveillance terminals. In response to a hazard occurring, the surveillance center changes a surveillance setup of a surveillance terminal which has just detected the hazard and surveillance terminals falling in surrounding areas on the hazard locality, so that target zonal cooperative surveillance is performed.

### BACKGROUND OF THE INVENTION

1. Field of the Invention

The present invention relates to a system and method of surveillance to detect the occurrence of a hazard of crime, calamities, etc. and alert residents in the locality of the hazard and its vicinity.

2. Description of the Related Art

In a prior art surveillance system where one ore more surveillance terminals with surveillance camera equipment are networked to a surveillance center, the surveillance center performs the surveillance control, using discrete links to each surveillance terminal. For example, when a surveillance terminal detects a hazard occurring, the surveillance center obtains information in various aspects of the hazard from the surveillance terminal that detected the hazard and strengthens the local surveillance (for example, refer to Kokai, Japanese Unexamined Patent Publication No. 2000-316146). Also, upon the detection of a hazard occurring, the surveillance center alerts residents in the locality of the hazard and its vicinity.

### BRIEF SUMMARY OF THE INVENTION

In prior art surveillance systems, the surveillance center performs intensive control only for the surveillance terminal that has just detected a hazard occurring. To other surveillance terminals, the surveillance center simply sends a hazard signal, but does not strengthen the surveillance and collect related data. Therefore, if the hazard source moves, the surveillance setup cannot be arranged immediately for the moving hazard source. This is because, only after another surveillance terminal in the vicinity of the initial hazard detects the hazard source, the surveillance center finds that the hazard source has moved to an area near the hazard locality. In other words, before another event of the same hazard arises in another area in the vicinity of the hazard locality, the surveillance setup for the moving hazard source cannot be strengthened. In surrounding areas on the initial hazard locality, there is a possibility of chain reaction happening of the same hazard, and this is a problem in security.

It is an object of the present invention to solve the above problem and provide a system and method of surveillance to support an early intensive surveillance setup in surrounding areas on the locality of a hazard.

A surveillance system in accordance with the present invention comprises two or more surveillance terminals, each comprising a hazard detecting unit, a hazard signal sending unit, and a video data sending unit; and a surveillance center to which the surveillance terminals are connected via a network and which comprises a unit for detecting a hazard signal from one or more of said surveillance terminals and a command sending unit for sending a surveillance command to the two or more surveillance terminals. In response to a hazard occurring, the surveillance center changes a surveillance setup of a surveillance terminal which has just detected the hazard and surveillance terminals falling in surrounding areas on the hazard locality. Such surveillance system will be referred to as a “cooperative surveillance system” hereinafter.

A surveillance method in accordance with the present invention is to detect a hazard with two or more surveillance terminals and a surveillance center to which the surveillance terminals are connected via a network. The surveillance method comprises the steps of detecting a hazard at one or more of the surveillance terminals, sending a hazard signal from the one surveillance terminal to the surveillance center, sending video data acquired at the surveillance terminals to the surveillance center, detecting the hazard signal from the one surveillance terminal at the surveillance center, and sending a surveillance command from the surveillance center to the surveillance terminals. In response to the hazard occurring, the surveillance center changes a surveillance setup of a surveillance terminal which has just detected the hazard and surveillance terminals falling in surrounding areas on the hazard locality.

In the foregoing system and method, when a hazard occurs, video data is acquired from the surveillance terminal that has just detected the hazard and acquired in advance from the surveillance terminals in the surrounding areas on the hazard locality before another hazard happening and the surveillance setup can be strengthened prior to another event of the same hazard happening in a surrounding area.

### BRIEF DESCRIPTION OF THE SEVERAL VIEW OF THE DRAWINGS

These and other objects, features and advantages of the present invention will become more readily apparent from the following detailed description when taken in conjunction with the accompanying drawings wherein:

FIG. 1 shows a cooperative surveillance system in accordance with a preferred Embodiment 1 of the present invention.

FIG. 2 shows an example of signaling flow in the system of Embodiment 1 shown in FIG. 1.

FIG. 3 shows a cooperative surveillance system in accordance with a preferred Embodiment 2 of the present invention.

FIG. 4 shows an example of signaling flow in the system of Embodiment 2 shown in FIG. 3.

FIG. 5 shows a cooperative surveillance system in accordance with a preferred Embodiment 3 of the present invention.

FIG. 6 shows an example of signaling flow in the system of Embodiment 3 shown in FIG. 5.

FIG. 7 shows another example of signaling flow in the system of Embodiment 3 shown in FIG. 5.

FIG. 8 shows a cooperative surveillance system in accordance with a preferred Embodiment 4 of the present invention.

FIG. 9 shows an example of signaling flow in the system of Embodiment 4 shown in FIG. 8.

FIG. 10 shows a cooperative surveillance system in accordance with a preferred Embodiment 5 of the present invention.

FIG. 11 shows yet another example of signaling flow in the system of Embodiment 3 shown in FIG. 5.

### DETAILED DESCRIPTION IF THE INVENTION

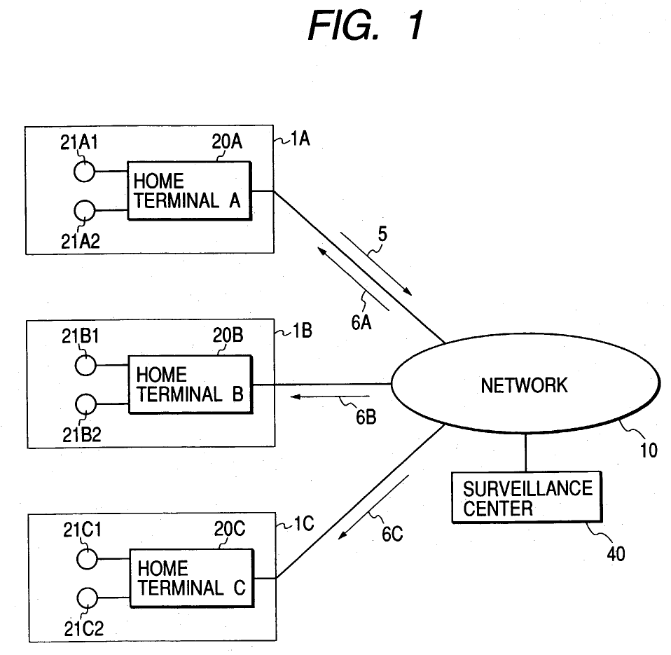

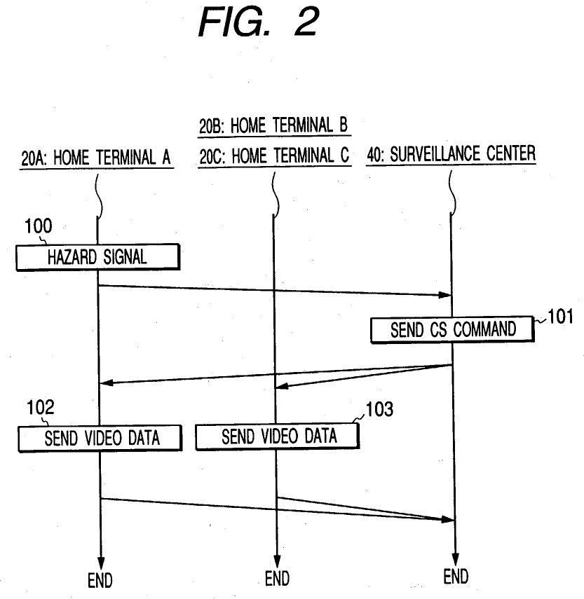

The present invention now is described more fully hereinafter with reference to the accompanying drawings, in which preferred embodiments of the invention are shown. FIG. 1 shows a cooperative surveillance system in accordance with a preferred Embodiment 1 of the present invention. FIG. 2 shows an example of signaling flow in the system of Embodiment 1.

The cooperative surveillance system of Embodiment 1 includes three homes 1A, 1B, 1C, each equipped with two surveillance cameras. In this system, cooperative surveillance is performed among the three homes. Equipment in home 1A consists of surveillance cameras 21A1 and 21A2 and a home terminal 20A. The surveillance cameras 21A capture the views around them and send video data of the views to the home terminal 20A. The home terminal 20A analyzes the video data and, if the video data meets predetermined conditions of hazard detection, sends a hazard signal 100 to the surveillance center over the network 10.

Equipment in home 1B consists of surveillance cameras 21B1 and 21B2 and a home terminal 20B. Equipment in home 1C consists of surveillance cameras 21C1 and 21C2 and a home terminal 20C. These equipments also operate as described for the equipment in home 1A.

Referring to FIG. 2, signaling in the system of Embodiment 1 will be explained for a case where a hazard has occurred in home 1A. When a hazard occurring is detected in home 1A, the home terminal 20A sends a hazard signal 100 to the surveillance center over the network 10. The surveillance center 40 detects the hazard detection signal 100 from the home 1A, sent over the network 10. Upon the detection of the hazard occurrence, the surveillance center 40 sends a command to do cooperative surveillance 101 to not only home 1A where the hazard has just occurred, also homes 1B and 1C in the vicinity of the home 1A. When the home terminals 20A, 20B, 20C receive cooperative surveillance commands 101A, 101B, 101C, respectively, they send video data 102, 103 to the surveillance center 40 through the network, thus strengthening the surveillance setup.

The video data is the video data of the views captured by the surveillance cameras 21A1, 21A2, 21B1, 21B2, 21C1, 21C2. Based on the video data received, the surveillance center 40 analyzes the hazard state in its both locality and vicinity, identifies the hazard source, and traces the hazard.

The video data of the views captured by the surveillance cameras is converted to digital signals. The conversion to digital signals should be performed by a suitable method such as MPEG (Moving Picture coding Experts Group)compression and encoding.

Each of the home terminals 20A, 20B, 20C can be configured to further include a storage unit to store temporarily or for a certain period the video data of the views captured by the surveillance cameras or the compressed and encoded data thereof.

According to the present embodiment (Embodiment 1), upon the occurrence of a hazard, video data from the terminals in the vicinity of the hazard locality as well as the terminal that has just detected the hazard is acquired prior to hazard spreading, and, thereby, the surveillance setup can be strengthened before another event of the same hazard occurs in the surrounding areas. Thus, a setup of crime prevention and evacuation can be strengthened in the surrounding areas on the hazard locality. Examples of hazard sources are a break-in, fire, etc.

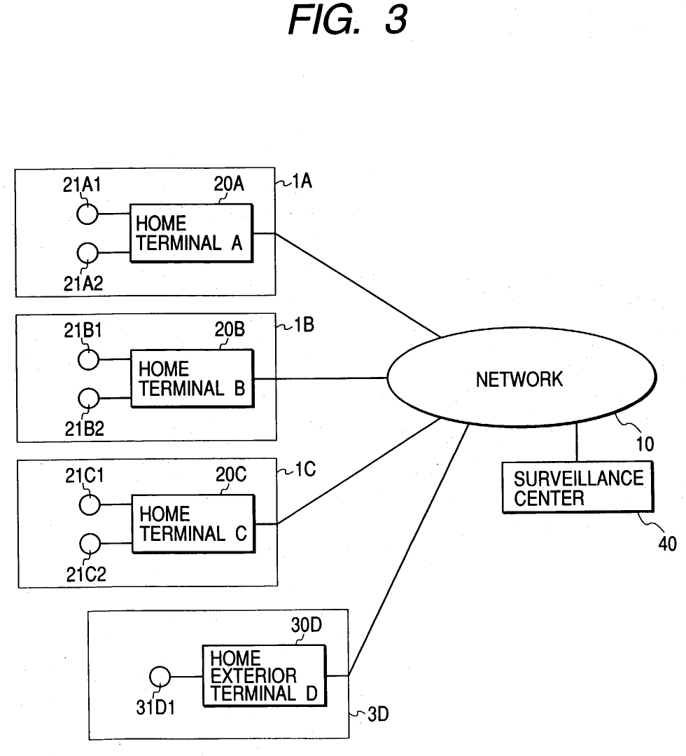

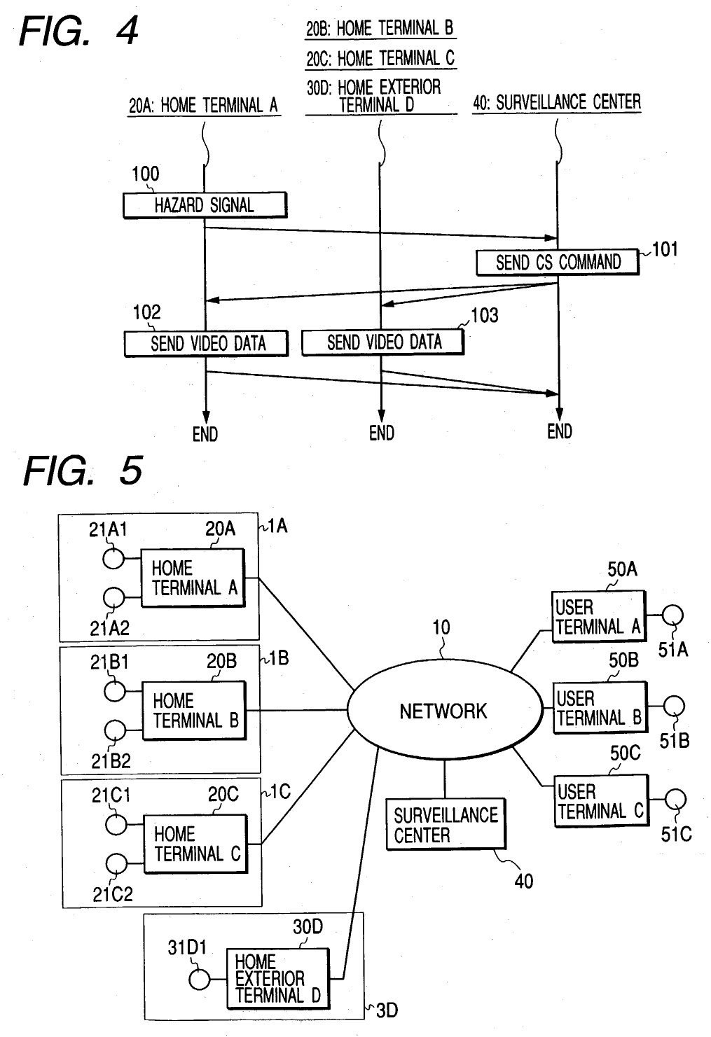

FIG. 3 shows a cooperative surveillance system in accordance with a preferred Embodiment 2 of the present invention. FIG. 4 shows an example of signaling flow in the system of Embodiment 2. The cooperative surveillance system of Embodiment 2 includes three homes 1A, 1B, 1C, each equipped with two surveillance cameras, and one unit of outside surveillance camera equipment installed in the neighborhood of the homes. In this system, cooperative surveillance is performed among the three homes and the outside surveillance camera equipment.

Equipment in home 1A consists of surveillance cameras 21A1 and 21A2 and a home terminal 20A. The surveillance cameras 21A capture the views around them and send video data of the views to the home terminal 20A. The home terminal 20A analyzes the video data and, if the video data meets predetermined conditions of hazard detection, sends a hazard signal to the surveillance center over the network 10. Equipment in other homes 1B and 1C is the same as the equipment in home 1A. The outside surveillance camera equipment 3D consists of a surveillance camera 31D1 and an outside terminal 30D. The surveillance camera 31D1 captures a view around it and sends video data of the captured view to the outside terminal 30D. The outside terminal 30D sends the video data 103 to the surveillance center 40 over the network 10 in response to a cooperative surveillance command from the surveillance center 40.

Referring to FIG. 4, signaling in the system of Embodiment 2 will be explained for a case where a hazard has occurred in home 1A. When a hazard occurring is detected in home 1A, the home terminal 20A sends a hazard signal 100 to the surveillance center 40. Upon the detection of the hazard occurrence, the surveillance center 40 sends a cooperative surveillance command 101 to not only home 1A where the hazard has just occurred, also homes 1B and 1C in the vicinity of the home 1A and the outside terminal 3D installed in the neighborhood of these homes. When the home terminals 20A, 20B, 20C, and the outside terminal 3D receive cooperative surveillance commands, respectively, they send video data 102, 103 to the surveillance center 40 through the network 10. The video data is the video data of the views captured by the surveillance cameras 21A1, 21A2, 21B1, 21B2, 21C1, 21C2 for the home terminals and the surveillance camera 31D1 connected to the home terminal 3D. Based on the video data received, the surveillance center 40 analyzes the hazard state in its locality, vicinity, and outside environment, and, thus, the hazard source can be identified and the hazard traced more exactly.

While the system of Embodiment 2 includes one outside terminal and one surveillance camera connected to the outside terminal, two or more outside terminals and surveillance cameras may be incorporated into the system, so that more accurate analysis can be performed.

An example of the outside surveillance camera is the one installed in a suitable place outside, that is, a stationary camera. Alternatively, a camera integrated into a mobile terminal, for example, a small camera integrated into a mobile phone or PDA may be used as the outside surveillance camera. Alternatively, a camera installed on an artificial satellite above the earth may serve as the camera for this purpose. In this case, as the network 10, a spatial, wireless network connecting the satellite and the surveillance center 40 is used.

In the system of Embodiment 2, surveillance is performed, using not only video data from the surveillance camera installed in the hazard locality, also video data from the surveillance cameral in the vicinity of the hazard locality. Thus, the hazard source can be traced continuously even if it moves. Also, the system of Embodiment 2 can prevent another event of the same hazard in another place to which the hazard source is moving. This system also allows easy elimination of the hazard source itself. With the above-noted features, the system of Embodiment 2 can carry out wide range surveillance covering surrounding areas on the hazard locality.

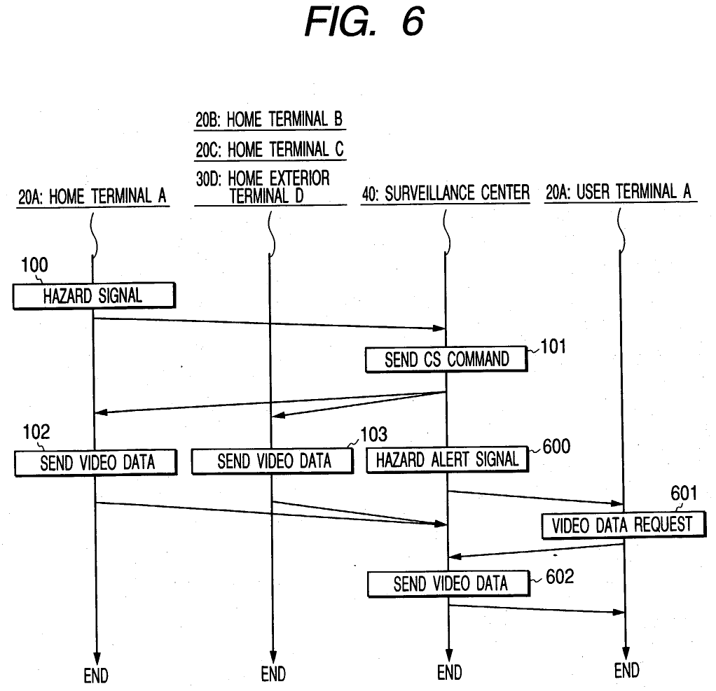

FIG. 5 shows a cooperative surveillance system in accordance with a preferred Embodiment 3 of the present invention. FIG. 6 shows an example of signaling flow in the system of Embodiment 3.

In the system of Embodiment 3, essentially, cooperative surveillance is performed among three homes 1A, 1B, 1C with their surveillance cameras and the outside surveillance camera equipment 3D. In addition, terminals that can receive data and are respectively used by the ones who live in the homes 1A, 1B, 1C, but are not home now, namely, user terminals 50A, 50B, 50C are connected to the network 10. Examples of the user terminals 50A, 50B, 50C are personal computers and mobile phones which are wired or wirelessly connected to the network 10. Equipment configurations and operation at the homes 1A, 1B, 1C, and the operation of the outside terminal 3D are the same as described in the foregoing embodiments.

In the system of Embodiment 3, for example, when a hazard occurs in home 1A, the surveillance center 40 sends a cooperative surveillance command 101 to the home 1A, homes 1B, 1C in its vicinity, and outside terminal 3D. In addition, the surveillance center 40 sends a hazard alert signal 600 to the home terminals 20A, 20B, 20C and the user terminals 50A, 50B, 50C.

When the user terminals 50A, 50B, 50C each receive the hazard alert signal 600, the user of each user terminal may issue a video data request 601 to the surveillance center 40. The surveillance center 40 supplies the requested video data to the requesting user terminal and the user can see the views inside his or her home.

If, for example, user A of the user terminal 50A issues a video data request 601 to the surveillance center 40, the surveillance center 40 sends the video data of the views inside the home 1A, which has been acquired from the home terminal A, to the user A. Then, the user A who lives in the home 1A where the hazard has just occurred can see the views inside his or her home. If user B of the user terminal 50B issues a video data request 601 to the surveillance center 40, the surveillance center 40 sends the video data of the views inside the home 1B, which has been acquired from the home terminal B to the user B. Then, the user B can see the views inside his or her home when the hazard has just occurred in the nearby home 1A and, consequently, chain reaction happening of the same hazard can be prevented.

If the user B stays at the home 1B when the hazard occurs in the home 1A, he or she can know the happening of the hazard in the particular area in the neighborhood of his or her home by detecting the hazard alert signal 600 sent from the surveillance center 40 and can take crime preventive actions for himself or herself.

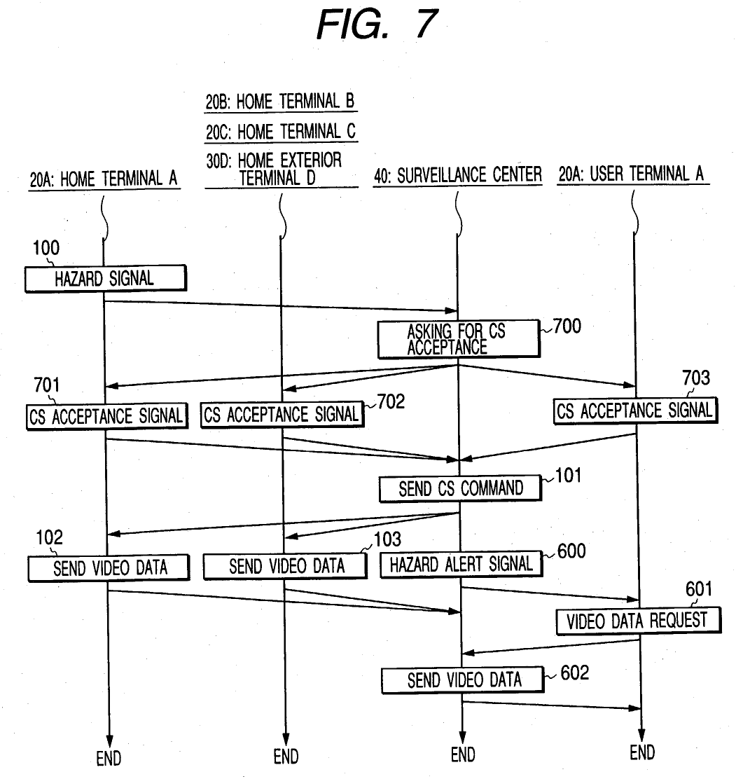

FIG. 7 shows another example of signaling flow in the system of Embodiment 3 shown in FIG. 5.

In the system of Embodiment 3, when a hazard occurs in home 1A, the surveillance center 40 sends a signal asking terminal if to accept cooperative surveillance 700 to the home terminals 20A, 20B, 20C and user terminals 50A, 50B, 50C. This asking signal asks the users if to accept cooperative surveillance, that is, asks an individual user if the user accepts sending of the video data of the views inside his or her home to the surveillance center 40. For example, when the surveillance center 40 sends the signal asking terminal if to accept cooperative surveillance to the user terminals 50A, 50B, 50C, if the user terminal 50A and 50C only return the acceptance signal in reply, the surveillance center 40 sends the cooperative surveillance command to the home terminals 20A and 20C only. The surveillance center does not send the cooperative surveillance command to the home terminal 20B. By using this manner of signaling, privacy protection can be provided so that the surveillance center 40 does not acquire video data of views inside the homes without the acceptance of the residents of the homes.

Arrangement can be made such that privacy protection will be disabled if a hazard beyond a certain level is detected; that is, when the surveillance center 40 determines that a hazard beyond a certain level occurs, the center issues the cooperative surveillance command to the terminals without the acceptance of the home residents. Examples of hazard sources beyond a certain level are housebreaker and fire accidents which are identified by the surveillance center, based on the video data obtained from the terminal at a home whose resident accepts the video data use.

According to the present embodiment (Embodiment 3), upon the occurrence of a hazard, the hazard alert signal is sent to residents who live in the home with the surveillance terminal which has just detected the hazard and residents who live in other homes with respective surveillance terminals in the vicinity of the hazard locality. Thus, a setup of crime prevention and evacuation can be strengthened in the surrounding areas on the hazard locality.

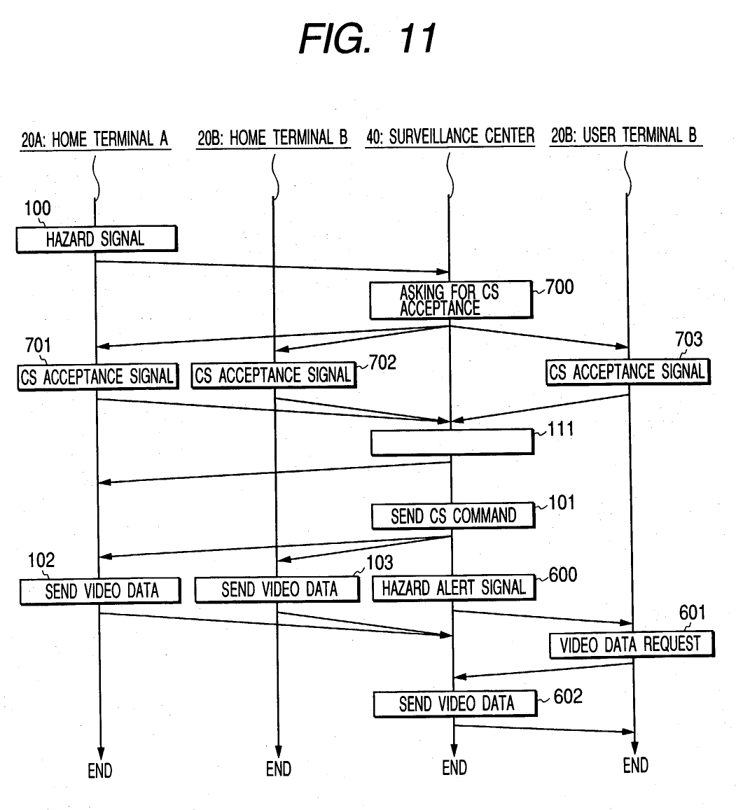

FIG. 11 shows yet another example of signaling flow in the system of Embodiment 3 shown in FIG. 5. This system offers the surveillance service at a charge to be paid by its users who live in the homes 1A, 1B, 1C. In this system, when a hazard occurs in home 1A, the surveillance center 40 sends a signal asking terminal if to accept cooperative surveillance to the users B and C who respectively live in the homes 1B and 1C in the vicinity of the hazard locality. When the users B and C living in the homes 1B and 1C in the vicinity of the hazard locality send the cooperative surveillance acceptance to the surveillance center 40, the surveillance center 40 grants a premium to the users B and C. Examples of the premium are discounting the surveillance service charge and adding points which are used to get the surveillance service or an additional service.

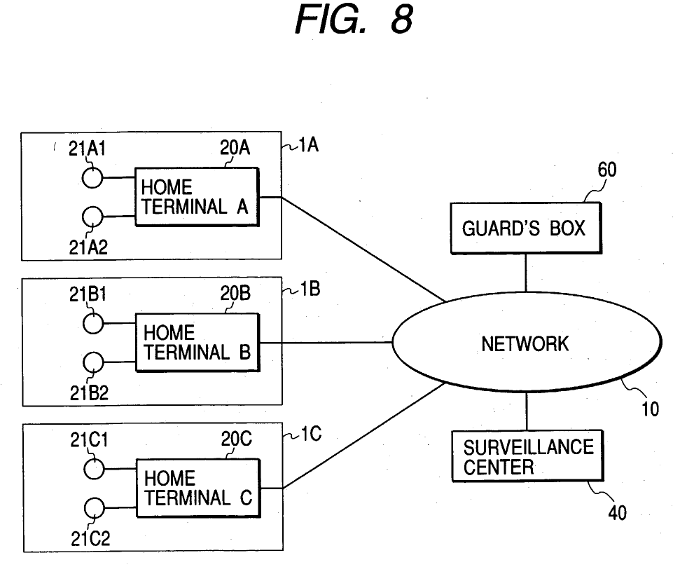

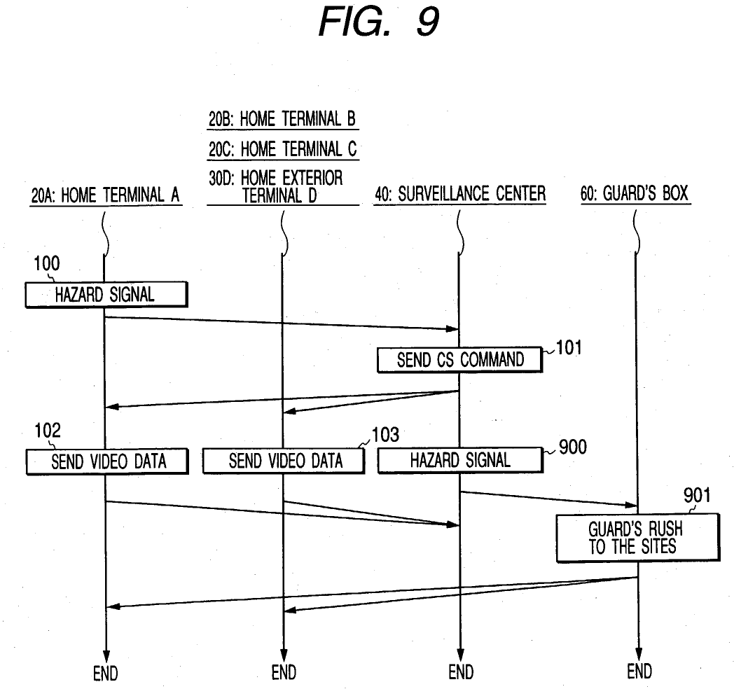

FIG. 8 shows a surveillance system in accordance with a preferred Embodiment 4 of the present invention. FIG. 9 shows an example of signaling flow in the system of Embodiment 4.

In the system of Embodiment 4, essentially, cooperative surveillance is performed among three homes 1A, 1B, 1C, and, moreover, the surveillance center 40 sends a hazard signal 900 to a special function agency upon the reception of a hazard signal 100 from a home terminal. The system includes a guard's box 60 as an example of the special function agency. Upon the reception of the hazard signal 900 from the surveillance center 40, guards at the guard's box 60 rush to the sites 901.

By this system configuration, the hazard source can be identified and eliminated quickly. Arrangement can be made such that, upon the reception of the hazard signal 900, the guard's box 60 issues a video data request to the surveillance center and, in response to the request, the video data sent from the home terminals to the surveillance center 40 is forwarded to the guard's box. By this system arrangement, the guards at the guard's box can grasp the situation of the hazard immediately. Other examples of the special function agency are a police related agency, medical agency, and fire-fighting related agency. In conjunction with these special function agencies, the system can take appropriate emergency measures to save the residents from the hazard, hazard source, and matters arising from the hazard.

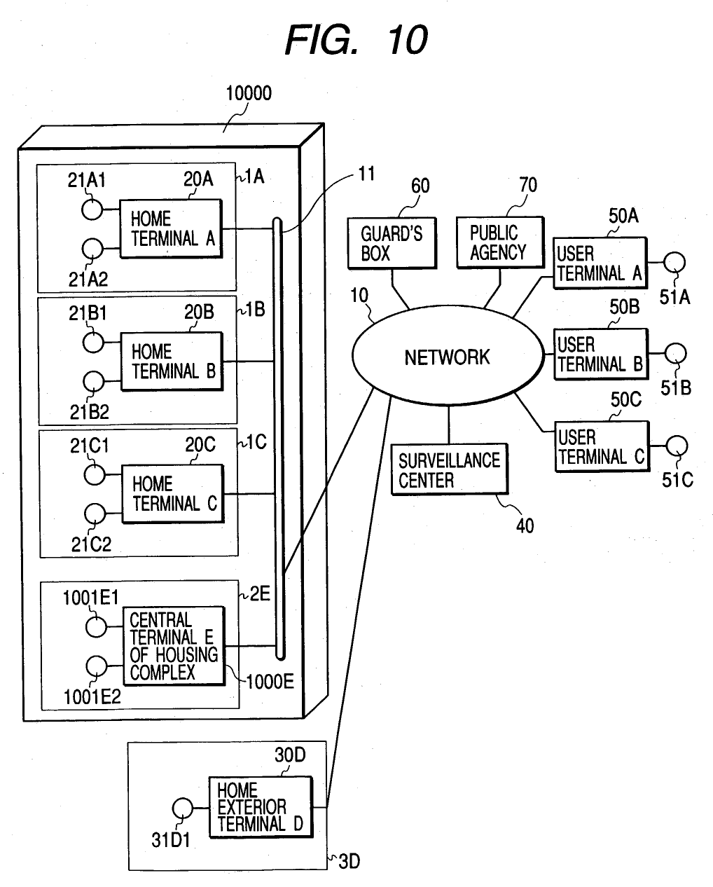

FIG. 10 shows a surveillance system in accordance with a preferred Embodiment 5 of the present invention.

The cooperative surveillance system of Embodiment 5 is an example illustrative of such system applied to a housing complex 10000 such as apartments, condominiums, and hotels. In the housing complex, in addition to the surveillance cameras in the homes, surveillance cameras for common use are installed in a common use space such as a hallway, and cooperative surveillance is performed within the housing complex.

The housing complex 10000 consists of homes 1A, 1B, 1C, and a common use space. In the common use space, a central terminal of the housing complex 1000E is installed. The central terminal of the housing complex 1000E consists of surveillance cameras 1001E1, 1001E2, and a terminal for common use 1000E. The surveillance cameras 1001E1, 1001E2 are installed in the common use space such as, for example, a hallway inside the housing complex, capture the views around them, and send the video data of the views to the terminal 20A for common use 1000E. The terminal for common use 1000E analyzes the video data and, if the video data meets predetermined conditions of hazard detection, sends a hazard signal to the surveillance center via a local network 11 in the building and the network 10.

In the system of Embodiment 5, when a hazard occurs in home 1A, the surveillance center 40 sends a cooperative surveillance command 101 to not only the home terminals 20A, 20B, 20C, also the terminal for common use 1000E. When the home terminals 20A, 20B, 20C, and the terminal for common use 1000E receive the cooperative surveillance command, they send video data 102, 103 to the surveillance center 40 through the network.

If a hazard source (such as a break-in offender) escapes in the housing complex, routes in which the offender runs away may be rather limited. By using the surveillance cameras for common use 1001E1, 1001E2, shown in Embodiment 5, which were installed in the common use space such as the hallway, the hazard source can be traced and another event of the same hazard prevented. This system allows easy capture and elimination of the hazard source.

By identifying the present location of a hazard occurring, based on the hazard signal and video data sent to the surveillance center 40, and controlling the surveillance cameras installed near that location to focus the surveillance on the zone around the hazard locality, the accuracy of tracing the hazard source can be enhanced.

Instead of the surveillance cameras shown in FIG. 1 or FIG. 10, thermal sensors, biosensors, and the various sensors may be used. As an example of application of the system of FIG. 10, an example of a fire prevention system using thermal sensors in place of the surveillance cameras will be described below. When fire occurs in home 1A, a thermal sensor 21A1 detects the fire and a hazard signal is sent to the surveillance center 40. Catching the fire occurring in the home, the surveillance center sends a fire alert signal to the user terminals 50A, 50B, 50C used by the residents, who are not home now, of the home 1A and the homes 1B and 1C in the vicinity of the home 1A as well as the home terminals 20A, 20B, 20C which are installed in the homes. Whether being at home or out, the residents of the homes can be alerted to the fire occurring.

By sending the fire alert to not only the home 1A where the fire has just occurred, also the homes 1B and 1C in the vicinity of the home 1A, the residents of the homes 1B and 1C, who are at home, can escape early away from the hazard. By sending video data and thermal sensor readout data in the surrounding zone on the hazard locality to the surveillance center 40, the surveillance center can grasp the detailed situation of the hazard. By providing the information obtained from the above data to a fire-fighting agency, a fire-fighting team can be put into action early to extinguish the fire.

According to the present invention, a surveillance system which supports an early intensive surveillance setup in surrounding areas on a hazard locality can be provided.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing descriptions. All changes which come within the meaning and range of equivalency of the claims are to be embraced within the scope of the claims.

What is claimed is:

1. A surveillance system comprising:
two or more surveillance terminals, each comprising a hazard detecting unit, a hazard signal sending unit, and a video data sending unit; and
a surveillance center to which said surveillance terminals are connected via a network and which comprises a unit for detecting a hazard signal from one or more of said surveillance terminals and a command sending unit for sending a surveillance command to said two or more surveillance terminals,
wherein, in response to a hazard occurring, said surveillance center changes a surveillance setup of a surveillance terminal which has just detected the hazard and surveillance terminals falling in surrounding areas on the hazard locality.

2. A surveillance system according to claim 1, wherein said each surveillance terminal is a home terminal equipped with one or two or more surveillance cameras installed inside a home, the home terminal including the hazard signal sending unit which detects a hazard, based on video data of views captured by said surveillance cameras, and sends a hazard signal.

3. A surveillance system according to claim 1, further comprising one or two or more outside surveillance terminals, each comprising a view capturing unit and a video data sending unit,
wherein said command sending unit of said surveillance center sends the surveillance command to said outside surveillance terminals as well and sending video data from said outside surveillance terminals to said surveillance center is performed in response to said surveillance command.

4. A surveillance system according to claim 3, wherein each of said outside surveillance terminals is equipped with one or two or more stationary cameras installed outside and said video data sending unit sends video data in response to the surveillance command.

5. A surveillance system according to claim 3, wherein each of said outside surveillance terminals is equipped with one or two or more mobile cameras and said video data sending unit sends video data in response to the surveillance command.

6. A surveillance system according to claim 3, wherein the function of said outside surveillance terminals is substituted by surveillance from a satellite.

7. A surveillance system according to claim 1, wherein said surveillance center sends a hazard alert signal to terminals that can receive data and are respectively used by the ones who each have said surveillance terminals.

8. A surveillance system according to claim 7, wherein said terminals that can receive data are personal computers.

9. A surveillance system according to claim 7, wherein said terminals that can receive data are mobile terminals.

10. A surveillance system according to claim 7, wherein each of said terminals that can receive data comprises a video data request sending unit, a video data receiving unit, and a video data display unit,
wherein, in response to a video data request sent from one of said terminals that can receive data, said surveillance center sends video data to the one of said terminals that can receive data.

11. A surveillance system according to claim 1, wherein, when said surveillance center receives said hazard signal, said command sending unit of said surveillance center sends the surveillance command to said surveillance terminals, said outside surveillance terminals, or said terminals that can receive data or sends the surveillance command to one or more surveillance terminals and external surveillance terminals that returned surveillance acceptance in reply to a signal asking terminal if to accept surveillance sent from said surveillance center to all terminals.

12. A surveillance system according to claim 1, wherein said surveillance center sends a hazard signal to a special function agency.

13. A surveillance system according to claim 12, wherein said special function agency is a guard's box and, when receiving said hazard signal, personnel thereof rush to the hazard locality and its surrounding areas.

14. A surveillance system according to claim 12, wherein said special function agency is a police agency, a medical agency, or a fire-fighting agency and, when receiving said hazard signal, personnel thereof rush to the hazard locality and its surrounding areas.

15. A surveillance system according to claim 1, wherein said each surveillance terminal is equipped with one or two or more sensors and said hazard detecting unit detects a hazard, based on data acquired from said sensors.

16. A surveillance system according to claim 1, wherein said each surveillance terminal includes a data storage unit which temporarily stores data acquired from said surveillance cameras or said sensors when a hazard occurs and immediately before and after the hazard occurrence moment.

17. A surveillance system according to claim 7, wherein, when a remote terminal user relevant to one surveillance terminal or the user of the one surveillance terminal in the vicinity of a surveillance terminal that has just detected a hazard returns surveillance acceptance to said surveillance center in reply to the signal asking terminal if to accept surveillance from said surveillance center, said surveillance center grants a premium to the terminal user.

18. A surveillance method for detecting a hazard with two or more surveillance terminals and a surveillance center to which the surveillance terminals are connected via a network, said surveillance method comprising the steps of:
detecting a hazard at one of said surveillance terminals;
sending a hazard signal from the one surveillance terminal to said surveillance center;
sending video data acquired at said surveillance terminals to said surveillance center;
detecting said hazard signal from the one surveillance terminal at said surveillance center; and
sending a surveillance command from said surveillance center to said surveillance terminals,
wherein, in response to the hazard occurring, said surveillance center changes a surveillance setup of a surveillance terminal which has just detected the hazard and surveillance terminals falling in surrounding areas on the hazard locality.

19. A surveillance method according to claim 18, wherein said surveillance center sends a hazard alert signal to terminals that can receive data and are respectively used by the ones who each have said surveillance terminals.

20. A surveillance method according to claim 19, wherein said surveillance method further comprises the steps:
sending a video data request from one of said terminals that can receive data to said surveillance center; and
sending video data from said surveillance terminal to the one of said terminals that can receive data in response to the video data request.
